(19) United States
(12) Patent Application Publication
(10) Pub. No.: US 2005/0185397 A1
(43) Pub. Date: Aug. 25, 2005

(54) Direct backlight module and assembly method thereof

(76) Inventor: Chi-Chih Chu, Yonghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/856,648

(22) Filed: May 28, 2004

(30) Foreign Application Priority Data
Feb. 20, 2004 (TW) 93104209

(51) Int. Cl. F21V 15/01

(52) U.S. Cl. 362/225

(57) ABSTRACT

A direct backlight module and assembly method thereof. The direct light type backlight module has a light diffusing plate, a frame, a reflective back plate, and a light source. The light diffusing plate has a first positioning portion on an edge of the light diffusing plate. The frame has a groove corresponding to the light diffusing plate, and a second positioning portion corresponding to the first positioning portion is provided in the groove. The reflective back plate is provided on a side of the frame, forming a cavity between the reflective back plate and the light diffusing plate for disposition of the light source. In assembly, the light diffusing plate is slotted in the groove of the frame to form a light diffusing module, and the light diffusing module is assembled with the reflective back plate and the light source to form the direct backlight module.

### BACKGROUND OF THE INVENTION

1. Field of the Invention

The present invention relates to a direct backlight module and an assembly method thereof, and particularly to a direct backlight module for a liquid crystal display (LCD) with a slot-in light diffusing plate.

2. Description of the Related Art

Generally, an LCD includes a liquid crystal panel and a backlight module. The liquid crystal panel provides the display function for the LCD. Since the liquid crystal panel does not emit light, light with sufficient brightness and uniform distribution is required to properly display images. The backlight module provides the light for the LCD. Further, a frame is applied to enclose the backlight module and the liquid crystal panel for protection of the LCD elements.

Generally, the backlight module can be categorized to direct and edge structures. In edge backlight modules, the light source is disposed on a side of the backlight module so that the volume of the backlight module can be reduced, and a light guide plate guides the light toward the liquid crystal panel. However, distribution of the light through the light guide plate is generally inconsistent.

Direct backlight modules present the light source directly in the cavity of the backlight module, which occupies a relatively larger volume of the backlight module. However, more than one lamp can be applied to enhance light emission, and the distribution of the light is more consistent.

FIG. 1 is a perspective view showing a conventional direct backlight module. In FIG. 1, the backlight module has a reflective back plate 110, a light diffusing plate 120, a lamp as light source 130, and a plurality of holding structures 140 to support the light source 130. Further, a plurality of additional optical film, e.g. a prism film or a protective diffusing plate, can be applied in the direct backlight module to enhance light usage or the diffusing rate. The optical film is not shown in FIG. 1, hence detailed description is omitted.

The above-mentioned elements in the conventional direct backlight module are mostly thin films or plates, and require a sequential stack and assembly process. Thus, stable assembly of the conventional direct backlight module is difficult. Further, the light source and the optical films of the direct backlight module are easily damaged during processing and transportation. When any element of the direct backlight module is damaged, the direct backlight module requires disassembly and reassembly to exchange the damaged element. This further increases cost and time of manufacturing and maintenance of the direct backlight module.

### SUMMARY OF THE INVENTION

Accordingly, an object of the present invention is to provide a direct backlight module and assembly method thereof, in which assembly and disassembly are simplified, reducing cost and time for manufacture and maintenance.

Another object of the present invention is to provide a direct backlight module and assembly method thereof, in which the light diffusing plate is configured to absorb impact and enhance rigidity, reducing element damage during processing and transportation.

The present invention accordingly discloses a direct backlight module with a light diffusing plate, a frame, a reflective back plate, and a light source. The light diffusing plate has a first positioning portion on its edge. The frame has a groove corresponding to the light diffusing plate, in which a second positioning portion is corresponding to the first positioning portion is provided. The reflective back plate is provided on a side of the frame, forming a cavity between the reflective back plate and the light diffusing plate for disposition of the light source.

Further, the present invention discloses an assembly method for the direct backlight module. A light diffusing plate and frame are provided. The light diffusing plate is inserted into the groove of the frame to form a light diffusing module, with a second positioning portion engaged with the first positioning portion. The light diffusing module is then assembled with the reflective back plate and the light source to form the direct backlight module, with the light source disposed between the reflective back plate and the light diffusing plate.

In the present invention, the first and second positioning portions can alternatively comprises a plurality of corresponding positioning holes and positioning pins.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional direct backlight module;

FIG. 2 is a schematic view of the direct backlight module of the present invention;

FIG. 3A is a perspective view showing the light diffusing plate and the frame in the module of FIG. 2;

FIG. 3B is a cross-section of engagement of the positioning pin and the positioning hole in the embodiment of FIG. 2; and

FIG. 4 is a flowchart of the assembly method of the direct backlight module of the present invention.

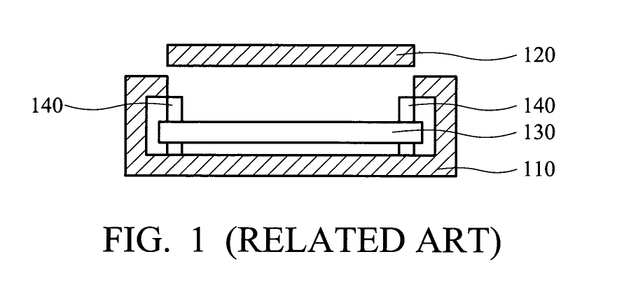

### DETAILED DESCRIPTION OF THE INVENTION

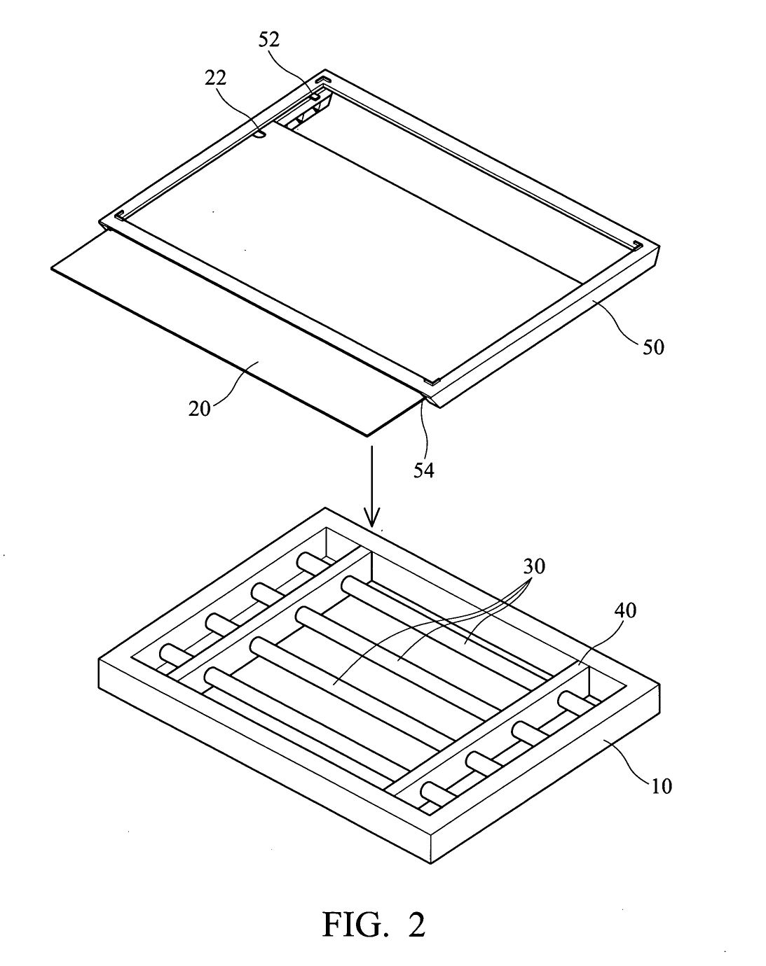

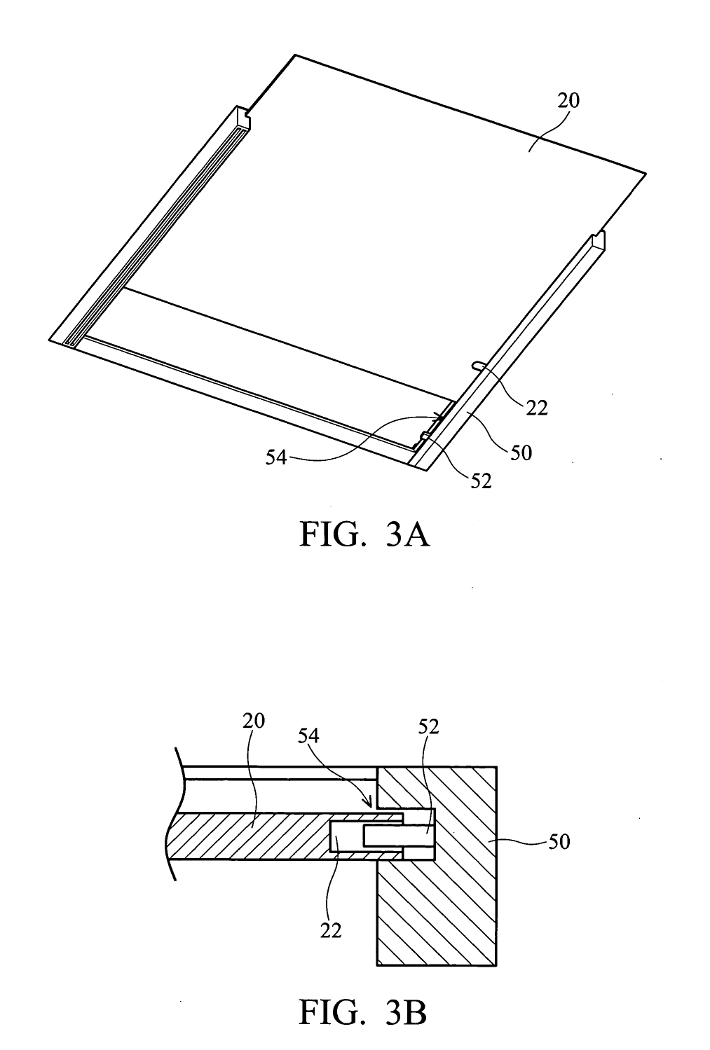

The direct backlight module of the present invention is described with reference to FIG. 2, FIG. 3A and FIG. 3B.

The direct backlight module comprises a reflective back plate 10, a light diffusing plate 20, a light source (i.e. the lamp) 30, a plurality of holding structures 40, and a frame 50. The elements are described hereinafter in detail.

As shown in FIG. 2, the reflective back plate 10 is provided on a side of the frame 50 (the bottom side in FIG. 2), forming a cavity between the reflective back plate 10 and the light diffusing plate 20 for disposition of the light source 30. The holding structures 40 are disposed between the light source 30 and the reflective back plate 10 for fixing the light source 30 stably to the reflective back plate 10.

Further, at least one positioning hole 22, as shown in FIG. 3A, is provided as the first positioning portion on an edge of the light diffusing plate 20. Correspondingly, the frame 50 has a groove 54 corresponding to the light diffusing plate 20, and the groove 54 has at least one positioning pin 52, as shown in FIG. 3A, as the second positioning portion corresponding to the first positioning portion (i.e. the positioning hole 22). FIG. 3B shows engagement of the positioning pin 52 with the positioning hole 22. Thus, when the light diffusing plate 20 is inserted into the groove 54 of the frame 50 to form a light diffusing module, the positioning pin 52 can be engaged with the positioning hole 22 to fix the light diffusing plate 20 and the frame 50.

It should be mentioned that in the above-mentioned configuration, the first positioning portion acts as positioning hole 22, and the second positioning portion as positioning pin 52. However, it is also acceptable for the first and second positioning portions to be other engaging structures. For example, the first positioning portion can be a positioning pin, and the second positioning portion a positioning hole corresponding to the positioning pin of the first positioning portion.

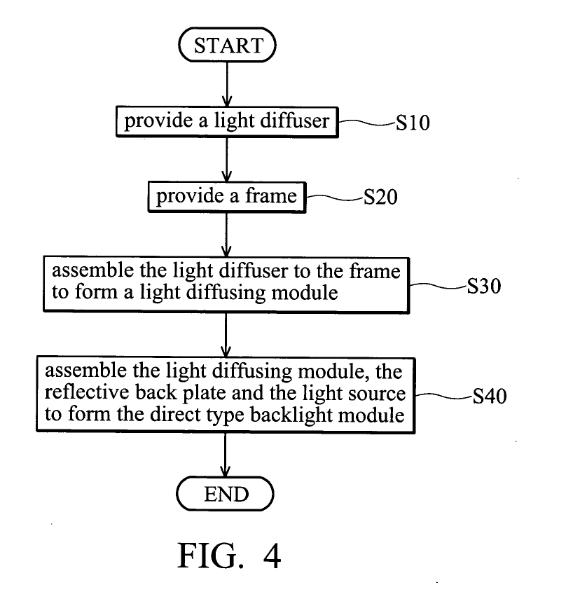

The assembly method of the direct backlight module is described with reference to the flowchart of FIG. 4.

In assembly of the direct backlight module, a light diffusing plate 20 as shown in FIG. 2 is provided (step S10), and a frame 50 as shown in FIG. 2 is provided (step S20). Then, the light diffusing plate 20 is inserted into the groove 54 of the frame 50 to form a light is diffusing module (step S30), with the second positioning portion (i.e. the positioning pin 52 in FIGS. 3A and 3B) engaged with the first positioning portion (i.e. the positioning hole 22 in FIGS. 3A and 3B). The light diffusing module is assembled with the reflective back plate 10 and the light source 30 forming the direct backlight module (step S40), in which the light source 30 is disposed in the cavity between the reflective back plate 10 and the light diffusing plate 20.

According to the present invention, the light diffusing plate 20 is slotted into the groove 54 of frame 50. Thus, assembly and disassembly of the direct backlight module is simplified. If any element in the direct backlight module is damaged during processing or transportation, the light diffusing plate 20 can be removed, and the damaged element exchanged without full disassembly. Accordingly, cost and time for manufacture and maintenance of the direct backlight module are reduced.

Further, in the direct backlight module of the present invention, the light diffusing plate 20 is slotted into the groove 54. The groove 54 can be optimally configured to absorb impact and enhance the rigidity of the backlight module, further reducing the possibility of element damage.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A direct backlight module, comprising:
a light diffusing plate with a first positioning portion on an edge thereof;
a frame with a groove corresponding to the light diffusing plate, the groove provided with a second positioning portion corresponding to the first positioning portion;
a reflective back plate disposed at a side of the frame, a cavity formed between the reflective back plate and the light diffusing plate; and
a light source disposed in the cavity.

2. The direct backlight module as claimed in claim 1, further comprising a plurality of holding structures disposed between the light source and the reflective back plate for fixing the light source to the reflective back plate.

3. The direct backlight module as claimed in claim 1, wherein the first positioning portion comprises a plurality of positioning holes.

4. The direct backlight module as claimed in claim 3, wherein the second positioning portion comprises a plurality of positioning pins respectively corresponding to the positioning holes.

5. The direct backlight module as claimed in claim 1, wherein the first positioning portion comprises a plurality of positioning pins.

6. The direct backlight module as claimed in claim 5, wherein the second positioning portion comprises a plurality of positioning holes respectively corresponding to the positioning pins.

7. An assembly method for a direct backlight module, comprising the steps of:
providing a light diffusing plate with a first positioning portion on an edge thereof;
providing a frame with a groove corresponding to the light diffusing plate, the groove provided with a second positioning portion corresponding to the first positioning portion;
slotting the light diffusing plate into the groove of the frame to form a light diffusing module, wherein the second positioning portion engages with the first positioning portion; and
assembling the light diffusing module with a reflective back plate and a light source to form the direct backlight module, wherein the light source is disposed between the reflective back plate and the light diffusing plate.

8. The assembly method as claimed in claim 7, wherein the first positioning portion comprises a plurality of positioning holes.

9. The assembly method as claimed in claim 8, wherein the second positioning portion comprises a plurality of positioning pins respectively corresponding to the positioning holes.

10. The assembly method as claimed in claim 7, wherein the first positioning portion comprises a plurality of positioning pins.

11. The assembly method as claimed in claim 10, wherein the second positioning portion comprises a plurality of positioning holes respectively corresponding to the positioning pins.
